(19) United States
(12) Patent Application Publication
(10) Pub. No.: US 2014/0172283 A1
(43) Pub. Date: Jun. 19, 2014

(54) AVERAGE VEHICLE SPEED CALCULATION SYSTEM AND AVERAGE VEHICLE SPEED CALCULATION METHOD

(71) Applicant: INSTITUTE FOR INFORMATION INDUSTRY, Taipei (TW)

(72) Inventors: Jan-Shin HO, Magong City (TW); Wei-Shing WANG, New Taipei City (TW); Pei-Sen LIU, New Taipei City (TW); Kuen-Tai CHEN, Taipei City (TW)

(73) Assignee: INSTITUTE FOR INFORMATION INDUSTRY, Taipei (TW)

(21) Appl. No.: 13/714,808

(22) Filed: Dec. 14, 2012

(51) Int. Cl. G08G 1/00

(52) U.S. Cl. CPC G08G 1/00
USPC 701/119

(57) ABSTRACT

An average vehicle speed calculation system and an average vehicle speed calculation method thereof are provided. The average vehicle speed calculation system comprises a calculation module and a mobile body. The mobile body includes a body speed detector, a radar speed detector and a transceiver. The body speed detector detects a body speed. The radar speed detector detects at least one speed of an adjacent vehicle. The transceiver connects to the calculation module via a network, and transmits the body speed and the at least one speed of the adjacent vehicle to the calculation module. The calculation module calculates an average vehicle speed according to the body speed and the at least one speed of the adjacent vehicle.

### FIELD

The present invention relates to an average vehicle speed calculation system and an average vehicle speed calculation method thereof More particularly, the average vehicle speed calculation system and the average vehicle speed calculation method thereof of the present invention substantially determine an actual vehicle speed according to a speed of an adjacent vehicle.

### BACKGROUND

Detection and estimation of a traffic flow in a specific road section usually act as an important basis for traffic flow management and for determining whether a driver needs to change his route. Therefore, accuracy of the detection and estimation of the traffic flow is very important. Conventionally, two kinds of systems are usually used to detect a traffic flow of a specific road section, namely, the infrastructure-based system and the infrastructure-free system.

Specifically in the infrastructure-based system, a sensor or an image detection device (e.g., a ground-based induction coil or a video camera) is usually installed in a specific road section to directly determine moving conditions of a vehicle and to calculate a speed of the vehicle therefrom. However, this leads to a high hardware cost and the application scope is very limited.

On the other hand, in the infrastructure-free system, a speed reporting device disposed on a common vehicle (e.g., a bus or a taxi) is usually used to directly report to the system a driving speed of the vehicle in a specific road section. However, because only the speed of the single vehicle is reported, the accuracy is liable to influence of driving characteristics of the vehicle (e.g., the bus generally has a relatively low speed, and the taxi generally has a relatively high speed).

Accordingly, an urgent need exists in the art to provide a solution of calculating a vehicle speed in a specific road section accurately within a large detection range and at a low cost.

### SUMMARY

To solve the aforesaid problems, the present invention provides an average vehicle speed calculation system and an average vehicle speed calculation method thereof, which substantially determine an actual vehicle speed more accurately according to a speed of a mobile body and a speed of an adjacent vehicle.

To achieve the aforesaid objective, certain embodiments of the present invention provide an average vehicle speed calculation system, which comprises a calculation module and a mobile body. The mobile body further comprises a body speed detector, a radar speed detector and a transceiver. The body speed detector is configured to determine a body speed of the mobile body. The radar speed detector is configured to detect at least one speed of an adjacent vehicle. The transceiver is connected to the calculation module via a network, and is configured to transmit the body speed and the at least one speed of the adjacent vehicle to the calculation module. The calculation module calculates an average vehicle speed according to the body speed and the at least one speed of the adjacent vehicle.

To achieve the aforesaid objective, certain embodiments of the present invention further provide an average vehicle speed calculation method for the aforesaid average vehicle speed calculation system, which comprises the following steps of: (a) enabling the body speed detector to determine a body speed of the mobile body; (b) enabling the radar speed detector to detect at least one speed of an adjacent vehicle; (c) enabling the transceiver to transmit the body speed and the at least one speed of the adjacent vehicle to the calculation module; and (d) enabling the calculation module to calculate an average vehicle speed according to the body speed and the at least one speed of the adjacent vehicle.

The detailed technology and preferred embodiments implemented for the subject invention are described in the following paragraphs accompanying the appended drawings for people skilled in this field to well appreciate the features of the claimed invention. It is understood that the features mentioned hereinbefore and those to be commented on hereinafter may be used not only in the specified combinations, but also in other combinations or in isolation, without departing from the scope of the present invention.

### BRIEF DESCRIPTION OF THE DRAWINGS

FIG. 1A is a schematic view illustrating a road application of an average vehicle speed calculation system according to a first embodiment of the present invention;

FIG. 1B is a schematic view illustrating a mobile body according to the first embodiment of the present invention;

FIG. 2A is a schematic view illustrating a road application of an average vehicle speed calculation system according to a second embodiment of the present invention;

FIG. 2B is a schematic view illustrating a mobile body according to the second embodiment of the present invention;

FIG. 3 is a flowchart diagram of an average vehicle speed calculation method according to a third embodiment of the present invention; and

FIG. 4 is a flowchart diagram of an average vehicle speed calculation method according to a fourth embodiment of the present invention.

### DETAILED DESCRIPTION

In the following descriptions, the present invention will be explained with reference to example embodiments thereof However, these example embodiments are not intended to limit the present invention to any example, embodiment, environments, applications or implementations described in these embodiments. Therefore, description of these embodiments is only for purpose of illustration rather than to limit the present invention. It shall be appreciated that, in the following embodiments and the attached drawings, elements not directly related to the present invention are omitted from depiction.

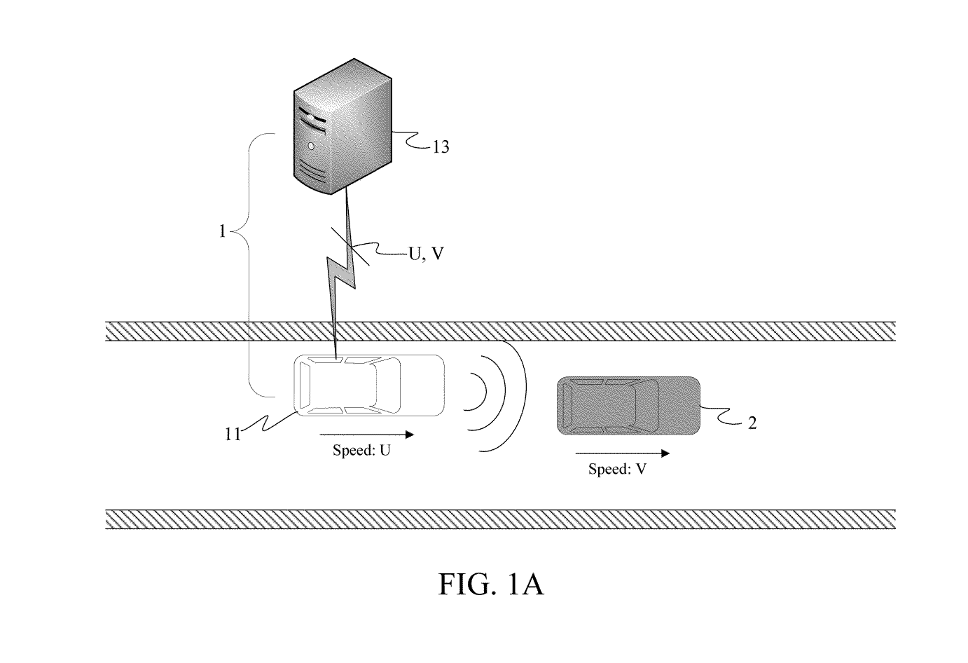

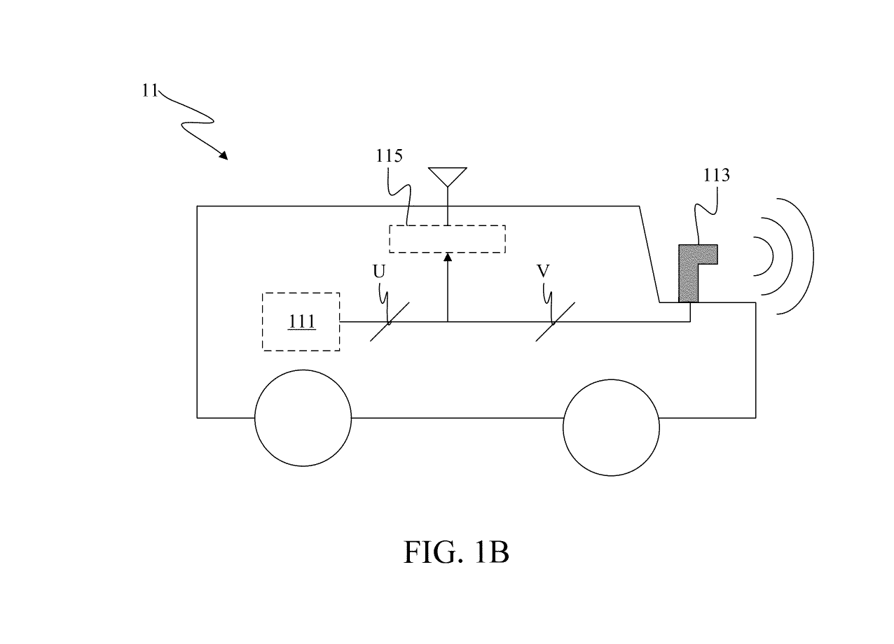

Refer to FIG. 1A and FIG. 1B. FIG. 1A is a schematic view illustrating a road application of an average vehicle speed calculation system 1 according to a first embodiment of the present invention. The average vehicle speed calculation system 1 comprises a mobile body 11 and a calculation module 13. FIG. 1B is a schematic view illustrating the mobile body 11 according to the first embodiment of the present invention. The mobile body 11 comprises a body speed detector 111, a radar speed detector 113 and a transceiver 115.

It shall be particularly appreciated that, in the first embodiment, the mobile body 11 and the calculation module 13 are disposed separately; however, this is not intended to limit the implementations of the present invention, and an example where the calculation module 13 is disposed on the mobile body 11 can be readily devised by people skilled in the art according to the technical disclosures of the present invention.

Additionally, the mobile body 11 of the first embodiment is a vehicle, and the calculation module 13 is a computer server. However, likewise, this is not intended to limit the implementations of the mobile body 11 and the calculation module 13; and people skilled in the art can also readily devise that the mobile body 11 may be any mobile object having mobility and the calculation module 13 may be a device having the calculation capability according to the technical disclosures of the present invention. Interactions among the components of the first embodiment will be further elucidated hereinbelow.

Firstly, the body speed detector 111, which is a speed detector disposed in the mobile body 11, is configured to detect a body speed U of the mobile body 11. The radar speed detector 113, which is a speed detector disposed on the mobile body 11, is configured to detect at least one speed V of an adjacent vehicle 2. Then, the transceiver 115 is connected to the calculation module 13 via a network, and transmits the body speed U and the at least one speed V of the adjacent vehicle 2 to the calculation module 13. Then, the calculation module 13 can calculate an average vehicle speed according to the body speed U and the at least one speed V of the adjacent vehicle 2. The average vehicle speed is the optimal value conforming to the actual vehicle speed. Additionally, people skilled in the art can know from the aforesaid technical contents of the present invention that, the more the number of speed data of the adjacent vehicle (e.g., a plurality of speeds V₁˜V_{N} of the adjacent vehicle) detected by the radar speed detector is, the more accurate the average vehicle speed calculated by the calculation module will be. This will not be further described herein.

It shall be particularly appreciated that, in order to increase the accuracy of the at least one speed V of the adjacent vehicle 2 detected by the radar speed detector 113, the radar speed detector 113 determines the at least one speed V of the adjacent vehicle 2 according to the body speed U and by means of the Doppler effect. However, this is not intended to limit the way of determining the at least one speed V of the adjacent vehicle 2 by the radar speed detector 113 of the present invention.

Hereinbelow, why determining the average vehicle speed according to the speed of the adjacent vehicle can obtain a speed substantially consistent with the actual vehicle speed will be explained through mathematic expressions. Suppose that a conventional probe vehicle has an average speed of

$${\hat{V}}_{B} = \frac{1}{{N}_{u}} {\sum }_{j = 1}^{{N}_{u}} {u}_{j}$$

during measurement and \hat{V}_{B} has an expected value ū, where Nᵤ represents the number of data measured by the probe vehicle and uⱼ represents a speed of the probe vehicle j. Accordingly, the average vehicle speed calculated by the conventional probe vehicle has an estimated error variance σ_{B}², and σ_{B}²=E[(\hat{V}_{B}− Z̅)²], where Z̅ represents an expected value of the actual vehicle speed. Accordingly,

$${σ}_{B}^{2} = E [ {( {\hat{V}}_{B} - \overline{Z} )}^{2} ] = E [ \frac{1}{{N}_{u}^{2}} {\sum }_{i = 1}^{{N}_{u}} {\sum }_{j = 1}^{{N}_{u}} {u}_{i} {u}_{j} - 2 \overline{u} \times \overline{Z} + {\overline{Z}}^{2} ] = \frac{{σ}_{u}^{2}}{{N}_{u}} + {( \overline{u} - \overline{Z} )}^{2}$$

can be obtained through calculation and simplification, where σᵤ² represents a distribution variance of the probe vehicle.

Thus, it can be known from the simplified formula

$${σ}_{B}^{2} = \frac{{σ}_{u}^{2}}{{N}_{u}} + {( \overline{u} - \overline{Z} )}^{2}$$

that: even if there is an infinite number of data of the probe vehicle which makes

$$\frac{{σ}_{u}^{2}}{{N}_{u}}$$

very close to zero, the estimated error variance σ_{B}² of the average vehicle speed calculated by the probe vehicle still has a difference of (ū− Z̅)².

On the other hand, suppose that the average vehicle speed calculated by the average vehicle speed calculation system of the present invention is

$${\hat{V}}_{U} = \frac{1}{{N}_{U}} {\sum }_{j = 1}^{{N}_{U}} {Z}_{j} ,$$

where N_{U} represents the number of speed data of the adjacent vehicle and Zⱼ represents a detected speed of the adjacent vehicle j. Then, the average vehicle speed calculated by the average vehicle speed calculation system of the present invention has an estimated error variance σ_{U}²=E[(\hat{V}_{U}− Z̅)²], where Z̅ represents an expected value of the actual vehicle speed. In this case, because the expected value of the average vehicle speed \hat{V}_{U} calculated by the average vehicle speed calculation system of the present invention is

$$E [ {\hat{V}}_{U} ] = E [ \frac{1}{{N}_{U}} {\sum }_{j = 1}^{{N}_{U}} {Z}_{j} ] = \frac{1}{{N}_{U}} {\sum }_{j = 1}^{{N}_{U}} E [ {Z}_{j} ] = \overline{Z} , \\ {σ}_{U}^{2} = E [ {\hat{V}}_{U} - {\overline{Z}}^{2} ] = E [ {\hat{V}}_{U}^{2} ] - {\overline{Z}}^{2} = E [ \frac{1}{{N}_{U}^{2}} {\sum }_{j = 1}^{{N}_{U}} {\sum }_{i = 1}^{{N}_{U}} {Z}_{i} {Z}_{j} ] - {\overline{Z}}^{2} = \frac{{σ}^{2}}{{N}_{U}}$$

can be obtained through calculation and simplification, where σ² represents a distribution variance of the mobile body of the average vehicle speed calculation system.

Thus, it can be known from the simplified formula

$${σ}_{U}^{2} = \frac{{σ}^{2}}{{N}_{u}}$$

that: when there is an infinite number of data of the mobile body which makes

$$\frac{{σ}^{2}}{{N}_{u}}$$

very close to zero, the estimated error variance of the average vehicle speed calculated by the average vehicle speed calculation system of the present invention will become zero. In other words, the average vehicle speed calculated by the average vehicle speed calculation system of the present invention is just the actual average vehicle speed.

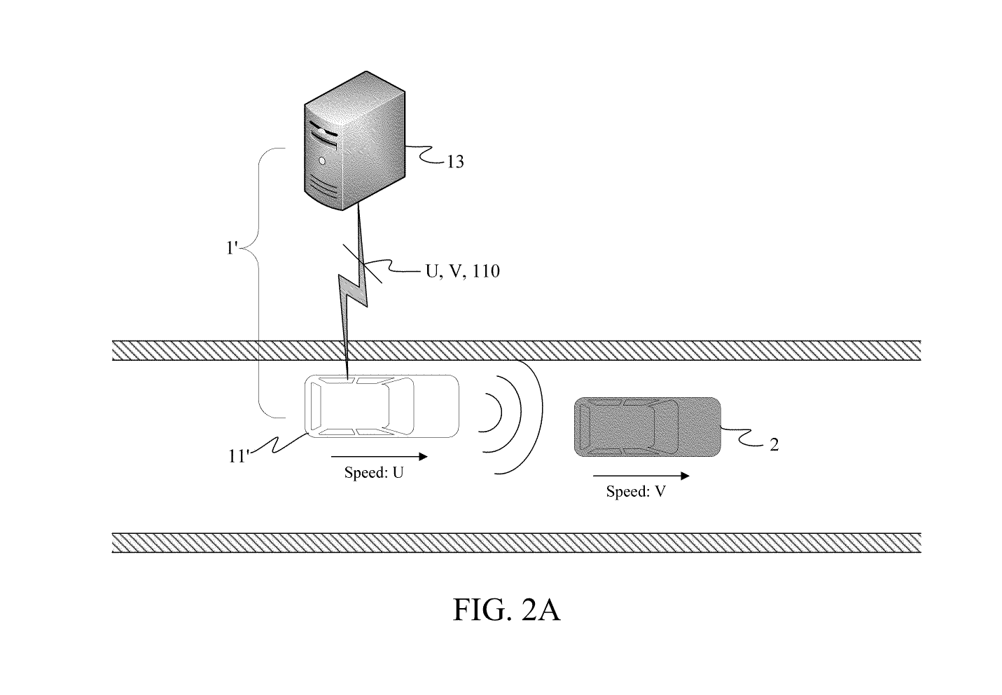

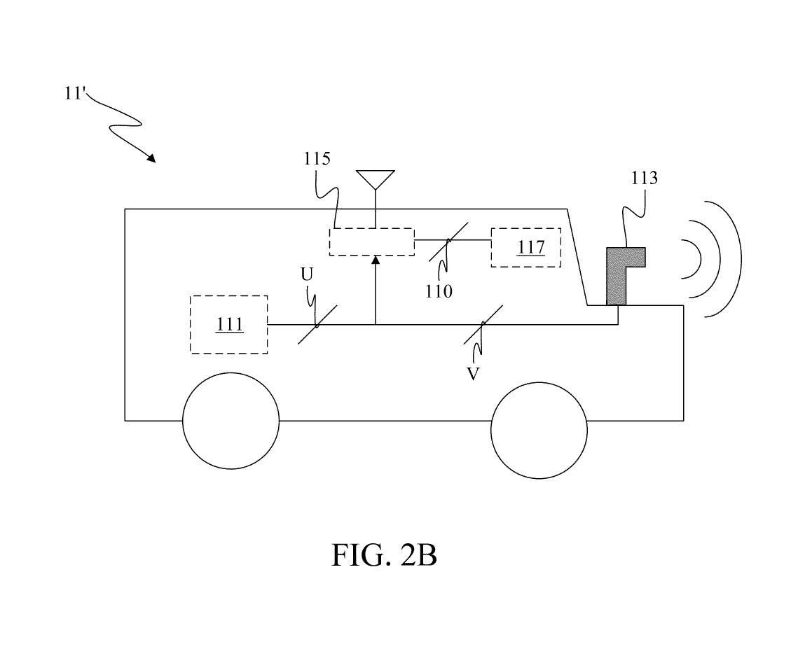

Refer to FIG. 2A and FIG. 2B. FIG. 2A is a schematic view illustrating a road application of an average vehicle speed calculation system 1′ according to a second embodiment of the present invention; and FIG. 2B is a schematic view illustrating a mobile body 11′ according to the second embodiment of the present invention. It shall be particularly appreciated that, the system architecture and the network connection environment of the second embodiment are the same as those of the previous embodiment, so the components with the same reference numerals also have the same functions and, thus, will not be further described herein. However, the second embodiment differs from the previous embodiment in that, the mobile body 11′ in the second embodiment further comprises a positioning device 117.

Likewise, the body speed detector 111, which is a speed detector disposed in the mobile body 11′, is configured to detect a body speed U of the mobile body 11′. The radar speed detector 113, which is a speed detector disposed on the mobile body 11′, is configured to detect at least one speed V of an adjacent vehicle 2. The positioning device 117, which is disposed on the mobile body 11′, is configured to determine a body position 110 of the mobile body 11′.

Then, the transceiver 115 is connected to the calculation module 13 via a network, and transmits the body position 110, the body speed U and the at least one speed V of the adjacent vehicle 2 to the calculation module 13. Then, the calculation module 13 can calculate an average vehicle speed of the mobile body 11′ at the body position 110 according to the body position 110, the body speed U and the at least one speed V of the adjacent vehicle 2.

It shall be particularly appreciated that, the positioning device 117 according to the second embodiment of the present invention may be a global positioning system (GPS) device, and the body position 110 comprises a GPS coordinate. However, this is not intended to limit the implementations of the positioning device and the body position of the present invention.

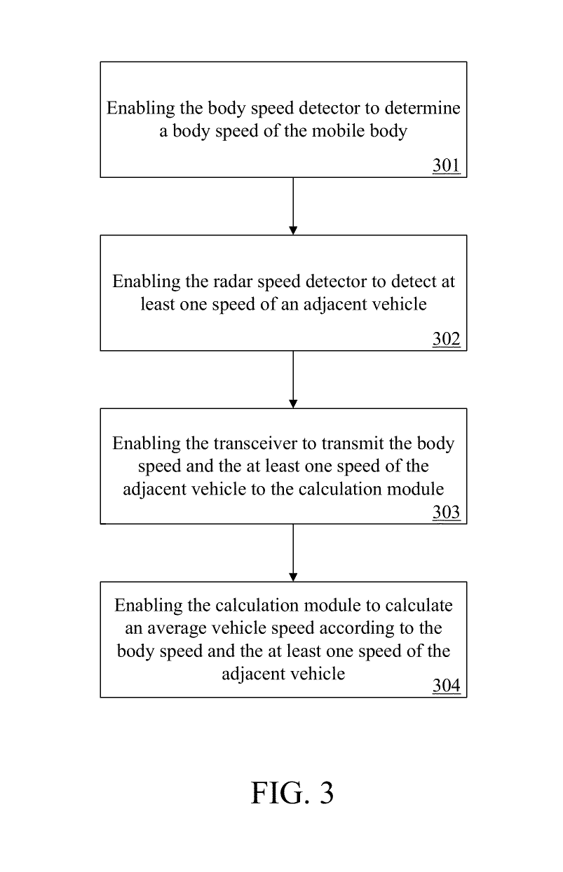

A third embodiment of the present invention is an average vehicle speed calculation method, a flowchart diagram of which is shown in FIG. 3. The average vehicle speed calculation method of the third embodiment is used in an average vehicle speed calculation system (e.g., the average vehicle speed calculation system 1 of the aforesaid embodiment). The average vehicle speed calculation system comprises a mobile body and a calculation module. The mobile body comprises a body speed detector, a radar speed detector and a transceiver. Detailed steps of the third embodiment are as follows.

Firstly, step 301 is executed to enable the body speed detector to determine a body speed of the mobile body. Step 302 is executed to enable the radar speed detector to detect at least one speed of an adjacent vehicle. Step 303 is executed to enable the transceiver to transmit the body speed and the at least one speed of the adjacent vehicle to the calculation module. Finally, step 304 is executed to enable the calculation module to calculate an average vehicle speed according to the body speed and the at least one speed of the adjacent vehicle. Similarly in the step 302, in order to increase the accuracy of the at least one speed of the adjacent vehicle detected by the radar speed detector, the radar speed detector can determine the at least one speed of the adjacent vehicle according to the body speed and by means of the Doppler effect.

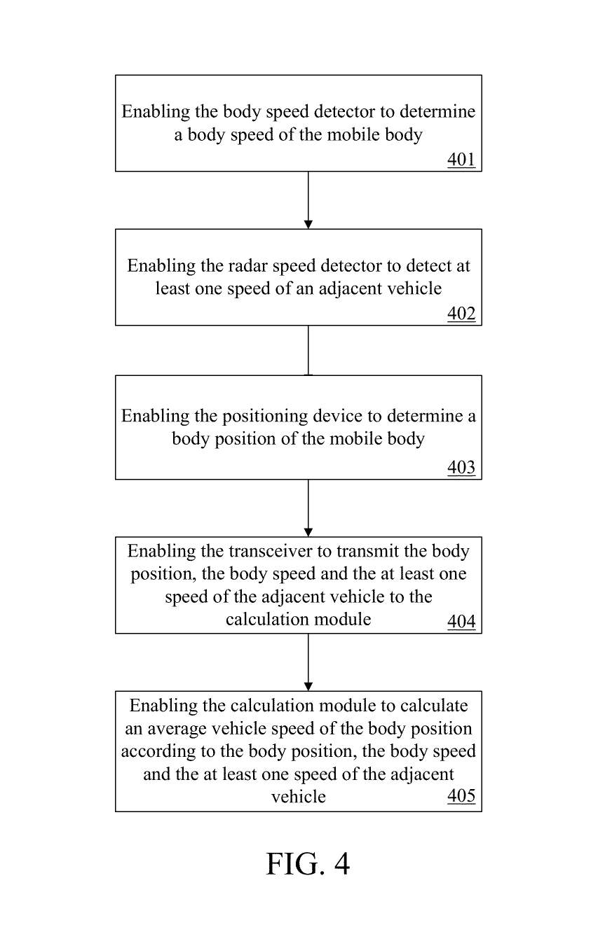

A fourth embodiment of the present invention is an average vehicle speed calculation method, a flowchart diagram of which is shown in FIG. 4. The average vehicle speed calculation method of the fourth embodiment is used in an average vehicle speed calculation system (e.g., the average vehicle speed calculation system 1′ of the aforesaid embodiment). The average vehicle speed calculation system comprises a mobile body and a calculation module. The mobile body comprises a body speed detector, a radar speed detector, a transceiver and a positioning device. Detailed steps of the fourth embodiment are as follows.

Firstly, step 401 is executed to enable the body speed detector to determine a body speed of the mobile body. Step 402 is executed to enable the radar speed detector to detect at least one speed of an adjacent vehicle. Step 403 is executed to enable the positioning device to determine a body position of the mobile body. Step 404 is executed to enable the transceiver to transmit the body position, the body speed and the at least one speed of the adjacent vehicle to the calculation module. Finally, step 405 is executed to enable the calculation module to calculate an average vehicle speed of the body position according to the body position, the body speed and the at least one speed of the adjacent vehicle.

Similarly, the positioning device according to the fourth embodiment of the present invention may be a GPS device, and the body position comprises a GPS coordinate. However, this is not intended to limit the implementations of the positioning device and the body position of the present invention either.

According to the above descriptions, the average vehicle speed calculation system and the average vehicle speed calculation method thereof of the present invention can calculate a vehicle speed in a specific road section accurately within a large detection range and at a low cost.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. An average vehicle speed calculation method for an average vehicle speed calculation system, the average vehicle speed calculation system comprising a mobile body and a calculation module, the mobile body comprising a body speed detector, a radar speed detector and a transceiver, and the transceiver being connected to the calculation module via a network, the average vehicle speed calculation method comprising the following steps of:
(a) enabling the body speed detector to determine a body speed of the mobile body;
(b) enabling the radar speed detector to detect at least one speed of an adjacent vehicle;
(c) enabling the transceiver to transmit the body speed and the at least one speed of the adjacent vehicle to the calculation module; and
(d) enabling the calculation module to calculate an average vehicle speed according to the body speed and the at least one speed of the adjacent vehicle.

2. The average vehicle speed calculation method as claimed in claim 1, wherein the mobile body further comprises a positioning device, the average vehicle speed calculation method further comprising the following step prior to the step (c):
(e) enabling the positioning device to determine a body position of the mobile body;
wherein the step (c) further comprises:
(c1) enabling the transceiver to transmit the body position, the body speed and the at least one speed of the adjacent vehicle to the calculation module;
wherein the step (d) further comprises the following step of:
(d1) enabling the calculation module to calculate the average vehicle speed of the body position according to the body position, the body speed and the at least one speed of the adjacent vehicle.

3. The average vehicle speed calculation method as claimed in claim 2, wherein the positioning device is a global positioning system (GPS) device, and the body position comprises a GPS coordinate.

4. The average vehicle speed calculation method as claimed in claim 1, wherein the step (b) further comprises the following step of:
(b1) enabling the radar speed detector to calculate the at least one speed of the adjacent vehicle according to the body speed and by means of the Doppler effect.

5. An average vehicle speed calculation system, comprising:
a calculation module; and
a mobile body, comprising
a body speed detector, being configured to determine a body speed of the mobile body;
a radar speed detector, being configured to detect at least one speed of an adjacent vehicle; and
a transceiver connected to the calculation module via a network, being configured to transmit the body speed and the at least one speed of the adjacent vehicle to the calculation module;
wherein the calculation module calculates an average vehicle speed according to the body speed and the at least one speed of the adjacent vehicle.

6. The average vehicle speed calculation system as claimed in claim 5, wherein the mobile body further comprises:
a positioning device, being configured to determine a body position of the mobile body;
wherein the transceiver is further configured to transmit the body position, the body speed and the at least one speed of the adjacent vehicle to the calculation module, and the calculation module is further configured to calculate the average vehicle speed of the body position according to the body position, the body speed and the at least one speed of the adjacent vehicle.

7. The average vehicle speed calculation system as claimed in claim 5, wherein the positioning device is a global positioning system (GPS) device, and the body position comprises a GPS coordinate.

8. The average vehicle speed calculation system as claimed in claim 5, wherein the radar speed detector calculates the at least one speed of the adjacent vehicle according to the body speed and by means of the Doppler effect.
